(19) United States
(12) Patent Application Publication
(10) Pub. No.: US 2013/0224473 A1
(43) Pub. Date: Aug. 29, 2013

(54) PREVENTION OF HYDROPHOBIC DEWETTING THROUGH NANOPARTICLE SURFACE TREATMENT

(71) Applicant: Research Foundation of the City University of New York, (US)

(72) Inventors: Barry Van Tassell, Poughkeepsie, NY (US); Daniel Steingart, Princeton, NJ (US); Eli S. Leland, New York, NY (US); Paul Chando, New York, NY (US); Limin Huang, Shenzhen (CN); Stephen O'Brien, Water Mill, NY (US)

(73) Assignee: Research Foundation of the City University of New York, New York, NY (US)

(21) Appl. No.: 13/775,938

(22) Filed: Feb. 25, 2013

Related U.S. Application Data
(60) Provisional application No. 61/602,267, filed on Feb. 23, 2012.

(51) Int. Cl. B05D 1/38

(52) U.S. Cl. CPC B05D 1/38; Y10S 427/00; B82Y 40/00
USPC 428/323; 427/214; 428/457; 977/932

(57) ABSTRACT

Disclosed in this specification is a method for coating a substrate to prevent dewetting. A suspension of nanoparticles is deposited onto the substrate to produce a nanoparticle layer. The nanoparticle layer is then coated with a monomer. The monomer polymerizes on the nanoparticle layer to produce a polymeric layer.

### CROSS-REFERENCE TO RELATED APPLICATIONS

This application claims priority to and the benefit of U.S. provisional patent application Ser. No. 61/602,267 (filed Feb. 23, 2012), which application is incorporated herein by reference in its entirety.

### STATEMENT REGARDING FEDERALLY FUNDED RESEARCH OR DEVELOPMENT

This invention was made with government support under contract no. SCIGM093930 awarded by the National Institute of Health (NIH), contact no. 0653056 awarded by the National Science Foundation (NSF), and contract no. DE-AR000014 awarded by the Department of Energy (ARPA-E ADEPT). The government has certain rights in the invention.

### FIELD OF THE INVENTION

This invention relates, in one embodiment, to a method for coating a substrate with a nanoparticle layer. The layer alters the surface of the substrate such that dewetting is prevented. The method is particularly useful when depositing a monomer that subsequently polymerizes to form a polymeric layer while on the nanoparticle layer.

### BACKGROUND

Coating substrates with polymeric surfaces is commonplace in a variety of fields, including the thin-film, energy storage and semiconductor industries. Often, the substrate and the polymer must be customized to prevent dewetting. In some situations, particular substrate/polymer combinations are simply not accessible due to excessive dewetting. Additionally or alternatively, the substrate may be delicate and/or costly and etching of the substrate is not permissible. The dewetting problem is particularly troublesome when the layer being deposited changes its properties during deposition. For example, a monomer may be deposited on a surface and not experience dewetting but, upon polymerization, the properties are altered and dewetting occurs. An alternative method for coating a substrate that prevents dewetting is desired.

### SUMMARY OF THE INVENTION

Disclosed in this specification is a method for coating a substrate to prevent dewetting. A suspension of nanoparticles is deposited onto the substrate to produce a nanoparticle layer. The nanoparticle layer is then coated with a monomer. The monomer polymerizes on the nanoparticle layer to produce a polymeric layer.

### BRIEF DESCRIPTION OF THE DRAWINGS

The present invention is disclosed with reference to the accompanying drawings, wherein:

FIG. 1A, FIG. 1B, FIG. 1C and FIG. 1D depict an exemplary dewetting problem;

FIG. 2A, FIG. 2B, FIG. 2C, FIG. 2D, FIG. 2E and FIG. 2F depict an exemplary method for addressing a dewetting problem; and

FIG. 3 is a flow diagram depicting an exemplary method for coating a substrate to prevent dewetting.

Corresponding reference characters indicate corresponding parts throughout the several views. The examples set out herein illustrate several embodiments of the invention but should not be construed as limiting the scope of the invention in any manner.

### DETAILED DESCRIPTION

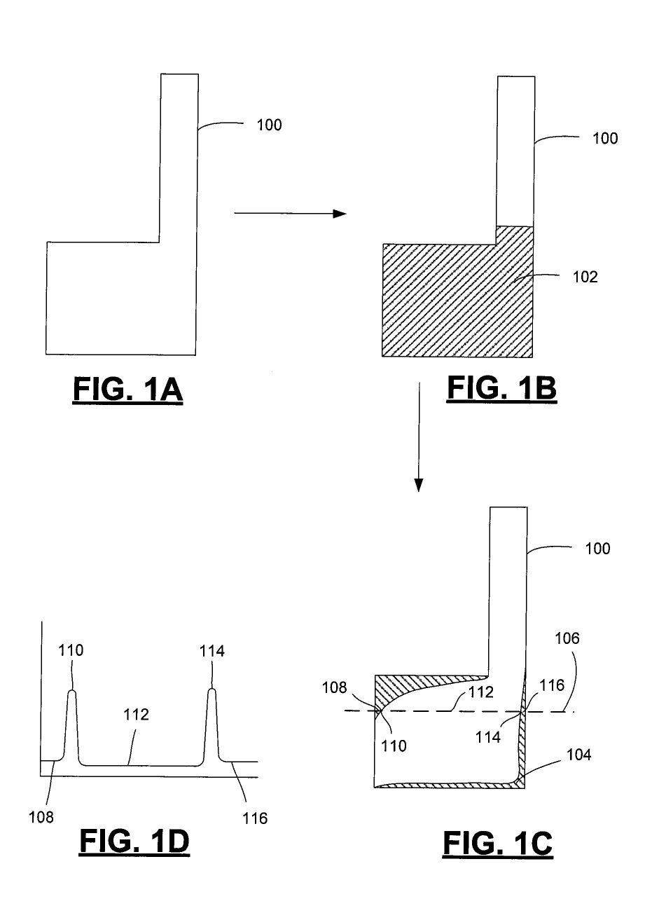

Referring to FIGS. 1A to 1C, an exemplary dewetting problem is illustrated. Dewetting is the beading of a liquid on a substrate surface. Dewetting negatively impact's the ability of a liquid to spread on the substrate surface which, in turn, produces non-uniform layers. In this exemplary embodiment a substrate 100 is coated with a suspension 102 of a polymer or monomer in an organic liquid. The organic liquid is allowed to evaporate which leaves a residual polymeric layer 104 on the substrate 100. In one exemplary embodiment, substrate 100 may be an aluminum electrode and suspension 102 may be a suspension of furfuryl alcohol in ethanol. As the solvent evaporates, the furfuryl alcohol polymerizes to form a polymeric layer 104 of polyfurfuryl alcohol. As depicted in FIG. 1C, polymeric layer 104 has experienced dewetting. This is evident from the accumulation of the polymeric layer 104 at the periphery of the substrate 100.

FIG. 1D is a surface profile of the coated substrate 100 of FIG. 1C along line 106. The region 108 corresponds to a portion of the polymeric layer 104 before a first edge 110. At the first edge 110 the height of the polymeric layer 104 increases rapidly. A lip that raises 1.5 micrometers above the remainder of the polymeric layer 104 is not uncommon. The region 112 corresponds to the uncoated portion of the substrate 100. At a second edge 114 the height of the polymeric layer 104 again increases rapidly. The region 116 corresponds to a portion of the polymeric layer 104 after the second edge 112. The non-uniformity (e.g. edges 110, 114) in the thickness of polymeric layer 104 is undesirable and is a consequence of dewetting.

The dewetting problem illustrated in FIG. 1C can occur whenever a hydrophoblic polymer is applied. The problem is particularly pronounced when the deposited suspension changes its hydrophobicity during deposition. For example, the monomer furfuryl alcohol is relatively hydrophilic. The corresponding polymer, polyfurfuryl alcohol, is relatively hydrophobic. During polymerization the hydrophilic/hydrophobic properties of the suspension change. This change greatly accentuates the dewetting problem.

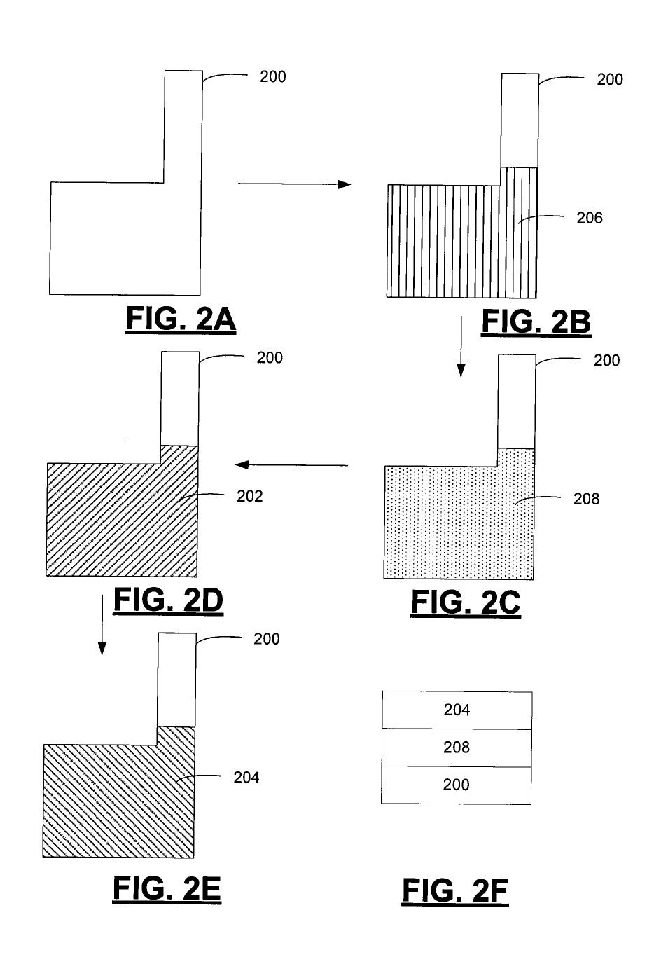

FIGS. 2A to 2F depicts an exemplary method for addressing a dewetting problem by facilitating the spreading of the liquid over a surface. In this exemplary embodiment a substrate 200 is coated with a nanoparticle suspension 206 that comprises nanoparticles and a liquid. After coating, the liquid is permitted to evaporate to leave a nanoparticle layer 208 on a surface of the substrate. Thereafter, a suspension 202 of a polymer or monomer in a liquid is deposited. In one embodiment, suspension 202 is a suspension of furfuryl alcohol. Other suitable monomers would be apparent to those skilled in the art after benefitting from reading this specification. The liquid in suspension 202 may be the same or different from the liquid in nanoparticle suspension 206. The liquid is allowed to evaporate which leaves a residual polymeric layer 204 on the substrate 200. As depicted in FIG. 2E, polymeric layer 204 has not experienced dewetting. This is evident from the uniform thickness of the polymeric layer 204 over the substrate 200. Advantageously, dewetting can be prevented without the use of surfactants or surface modification (e.g. etching) of the substrate 200. A side view of the coated substrate is schematically depicted in FIG. 2F. The nanoparticle layer 208 is deposited directly on the surface of the substrate 200. The polymeric layer 204 is deposited directly on the nanoparticle layer 208.

The nanoparticles generally have a diameter of from about 1 nm to about 1000 nm. In one embodiment, the nanoparticles have a diameter of from about 1 nm to about 50 nm. In another embodiment, the nanoparticles have a diameter of from about 8 nm to about 30 nm. The nanoparticles may be ceramic nanoparticles. Examples of suitable ceramic nanoparticles include barium titanate, strontium titanate, barium strontium titanate, silica, and metal-oxide ceramics. In another embodiment the nanoparticles are metallic nanoparticles. Examples of suitable metallic nanoparticles include silver, gold, and copper.

The nanoparticle layer 208 may be deposited by any conventional technique including, but not limited to, pressure-driven dispenser coating, spin coating, dip coating, spray coating, inkjet coating, gravure coating. The nanoparticle layer 208 may be deposited from a rapidly evaporating liquid in which the nanoparticles are insoluble and which has a density that approximately matches the density of the nanoparticles, thereby permitting the nanoparticles to remain suspended in the liquid for a sufficient period of time. For example, an alcohol liquid (e.g. ethanol, isopropanol, methanol) may be used, as well as other organic solvents (e.g. dimethylformamide). The nanoparticle may be present in the liquid at a concentration of from about 1 mg/mL to about 50 mg/mL. In another embodiment, the nanoparticle may be present in the liquid at a concentration of from about 10 mg/mL to about 30 mg/mL. In one embodiment, the entire surface of the substrate 200 is coated. In another embodiment, only a portion of the substrate 200 is coated. In one such embodiment, a patterned portion of the substrate 200 is coated using, for example, inkjet deposition and/or masking. The nanoparticle layer 208 generally has a thickness of less than about five hundred nanometers. In one embodiment, the nanoparticle layer 208 has a thickness of less than about one hundred nanometers. In yet another embodiment, the nanoparticle layer 208 has a thickness of a single monolayer.

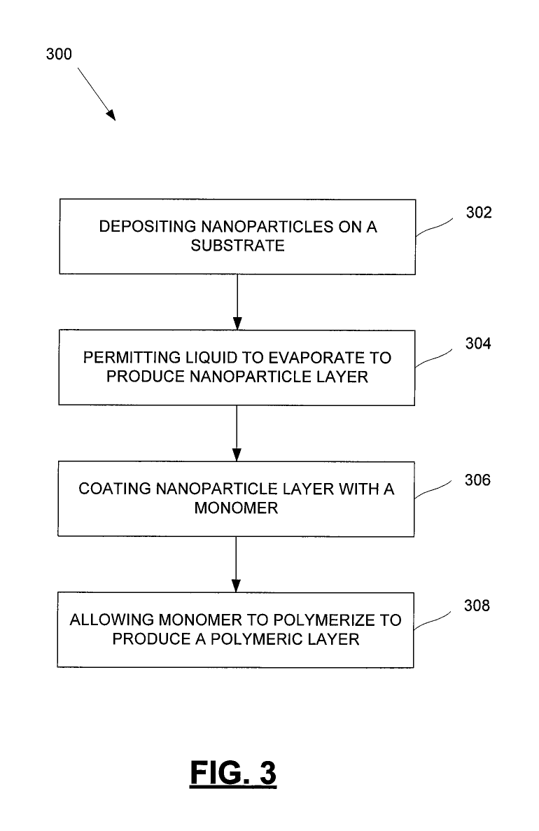

FIG. 3 is a flow diagram depicting an exemplary method 300 for coating a substrate to prevent dewetting. The method 300 comprises step 302 wherein a nanoparticle suspension is deposited in a liquid onto a surface of the substrate. For example, a suspension of barium titanate nanoparticles (8-30 nm) in ethanol may be deposited onto a surface of an aluminum electrode. In step 304, the liquid is permitted to evaporate the produce a nanoparticle layer on the surface. Thereafter, in step 306, the nanoparticle layer is coated with a monomer in either neat or diluted form. In step 308 the monomer is allowed to undergo a polymerization reaction to produce a polymeric layer on the nanoparticle layer.

Without wishing to be bound to any particular theory, Applicant believes the nanoparticle layer 208 provides a seed layer of particles that modifies the interactions between the nanoparticle layer 208 and the suspension 202. The suspension 202 sees the nanoparticle layer 208 as a substantially homogenous layer. Although multiple factors are likely responsible, Applicant believes the nanoparticles roughen the surface and permit the suspension 202 to become held between adjacent nanoparticles, thereby preventing dewetting. Advantageously, this surface roughening is accomplished without needing to etch or otherwise damage the surface of the substrate—a feature that is very desirable when producing microelectronics.

The methods described in this specification are particularly useful in preventing dewetting with suspensions that change their hydrophobicity during deposition (e.g. suspension of a monomer that polymerizes during deposition). Additionally, the methods described in this specification are particularly useful in prevent dewetting when the polymeric layer that is being deposited is a nanoparticle/polymer composite. In such situations the nanoparticle is a component of the resulting layer anyway and the dewetting can be prevented by altering the order in which the nanoparticle is added.

For example, metacapacitors are solid-state ceramic nanoparticle/polymer composites with multiple layers designed for integration with power conversion electronics. Attempts were made to produce metacapacitors using additively printed dielectric composite layers that were suspensions of the polymer and nanoparticle. When the nanoparticle was co-suspended with the polymer (see Example 2), substantial dewetting occurred and the desired metacapacitor was not produced. When the nanoparticle was first pre-deposited and the polymer layer was subsequently deposited on the nanoparticle layer, the desired metacapacitor was produced. Multi-layered capacitors could be produced by pre-depositing a layer of nanoparticles atop the substrate prior to polymer deposition of each individual layer.

### EXAMPLE 1—COMPARATIVE EXAMPLE

### No Nanoparticle

Furfuryl alcohol, a monomer in liquid form, was applied to an aluminum surface such that a uniform film of furfuryl alcohol approximately 100 nm thick remained on the surface. After heat above about 80 C to dry and polymerize the furfuryl alcohol, the material (now a polymer) had visibly undergone dewetting and had accumulated at the periphery of the aluminum surface leaving sections of the aluminum surface bare.

### EXAMPLE 2—COMPARATIVE EXAMPLE

### Nanoparticle Co-Suspended

0.225 mL of furfuryl alcohol monomer was mixed with 1.0 mL of ethanol, along with 9 mg of barium strontium titanate nanoparticles. The suspension was applied to an aluminum surface and dried to drive off the ethanol. It was then heated above about 80 C to polymerize the furfuryl alcohol such that a film of approximately 1 micron of polymer and nanoparticles remained on the surface. After this treatment, the polymer-nanoparticle composite had visibly undergone dewetting and had accumulated at the periphery of the aluminum surface leaving sections of the aluminum surface bare.

EXAMPLE 3

### Nanoparticle Pre-Deposited

A solution comprising barium strontium titanate nanoparticles and ethanol at a concentration of 20 mg of nanoparticles per 1 mL of ethanol was applied to an aluminum surface and dried in air such that the ethanol evaporated and the resulting nanoparticle film was approximately 50 nm thick. Furfuryl alcohol monomer was then applied to this surface on top of the nanoparticle film and heated to above 80 C to polymerize the monomer. After this deposition and treatment, no dewetting or film reconfiguration was observed and the aluminum surface remained covered.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. A method for coating a substrate to prevent dewetting, the method comprising the steps of:
depositing a suspension of nanoparticles in a liquid onto a surface of a substrate;
permitting the liquid to evaporate to produce a nanoparticle layer on the surface;
coating the nanoparticle layer with a monomer; and
allowing the monomer to polymerize to produce a polymeric layer on the nanoparticle layer.

2. The method as recited in claim 1, wherein the substrate is selected from the group consisting of aluminum, copper, silicon, a metal layer on glass and a metal layer on a flexible polymer.

3. The method as recited in claim 1, wherein the nanoparticles are ceramic nanoparticles with a diameter of from about 8 nm to about 50 nm.

4. The method as recited in claim 3, wherein the ceramic nanoparticles comprise a ceramic material selected from the group consisting of barium titanate, strontium titanate, barium strontium titanate, silica, and metal-oxide.

5. The method as recited in claim 1, wherein the nanoparticles are metal nanoparticles with a diameter of from about 8 nm to about 50 nm.

6. The method as recited in claim 5, wherein the metal nanoparticles comprise a metallic material selected from the group consisting of silver, gold, aluminum, or copper.

7. A method for coating a substrate to prevent dewetting, the method comprising the steps of:
depositing a suspension of nanoparticles in a liquid onto a surface of a metal substrate;
permitting the liquid to evaporate to produce a nanoparticle layer on the surface;
coating the nanoparticle layer with a monomer;
allowing the monomer to polymerize to produce a polymeric layer on the nanoparticle layer.

8. The method as recited in claim 7, wherein the nanoparticles are ceramic nanoparticles with a diameter of from about 1 nm to about 1000 nm.

9. The method as recited in claim 7, wherein the nanoparticles are ceramic nanoparticles with a diameter of from about 8 nm to about 50 nm.

10. The method as recited in claim 7, wherein the step of permitting the liquid to evaporate comprises heating the liquid to a temperature of at least about 80° C.

11. The method as recited in claim 7, wherein the step of depositing the suspension of nanoparticles comprises depositing the suspension in a predetermined pattern.

12. The method as recited in claim 7, wherein the step of depositing the suspension of nanoparticles comprises masking to provide a predetermined pattern.

13. A coated substrate formed by the method as recited in claim 7.

14. A layered substrate that resists dewetting, the layered substrate comprising:
a metal substrate;
a nanoparticle layer disposed on the metal substrate, the nanoparticle layer being from one monolayer thick to about five hundred nanometers thick and comprising nanoparticles with a diameter of from about 1 nm to about 1000 nm;
a polymeric layer disposed on the nanoparticle layer, the polymeric layer being the reaction product of a polymerization reaction of a monomer, the polymerization reaction occurring on the nanoparticle layer, wherein the monomer and the polymeric layer have different hydrophobicities.

15. The layered substrate as recited in claim 14, wherein the monomer is furfuryl alcohol and the polymeric layer comprises polyfurfuryl alcohol.

16. The layered substrate as recited in claim 15, wherein the metal substrate is selected from the group consisting of aluminum, copper, silicon, a metal layer on glass and a metal layer on a flexible polymer.
